(19) United States
(12) Patent Application Publication
(10) Pub. No.: US 2006/0248682 A1
(43) Pub. Date: Nov. 9, 2006

(54) Stacker hinge

(75) Inventors: Joseph Amarello JR., Acushnet, MA (US); Randy S. Amarello, Acushnet, MA (US)

Correspondence Address: KELLEY DRYE & WARREN LLP, 3050 K STREET, NW, SUITE 400, WASHINGTON, DC, 20007, US

(73) Assignee: J&R PLASTICS

(21) Appl. No.: 11/337,666

(22) Filed: Jan. 24, 2006

Related U.S. Application Data
(60) Provisional application No. 60/718,319, filed on Sep. 20, 2005.

(51) Int. Cl. E05D 7/10

(52) U.S. Cl. 16/262

(57) ABSTRACT

The present invention is a stacker hinge for use in the manufacture and stacking of parts in a stacker apparatus. The stacker hinge may comprise a housing and at least one flipper, wherein the at least one flipper attaches to the housing such that the at least one flipper hinges from a first position to a second position. The stacker hinge may possess a two-piece construction, a housing and a flipper, for the single stacker hinge and a three-piece construction, a housing and two flippers, for the dual stacker hinge. The flippers for the dual stacker hinge according to at least one embodiment of the present invention are substantially identical and interchangeable, such that only two different components, the housing and the flipper, need to be formed and manufactured for the single or the dual stacker hinge.

### CROSS REFERENCE TO RELATED APPLICATIONS

The present invention relates to, and is entitled to the benefit of the earlier filing date and priority of, Application No. 60/718,319, filed on Sep. 20, 2005, which is herein incorporated by reference as if fully set forth.

### FIELD OF THE INVENTION

Embodiments of the present invention are stacker hinges. More specifically, embodiments of the present invention are stacker hinges for use in the manufacture and stacking of parts in a stacker apparatus.

### BACKGROUND OF THE INVENTION

Embodiments of the present invention relate to a stacker hinge device to aid in the stacking of a number of objects and may be used in conjunction with a stacker apparatus. Generally, one example of a stacker apparatus comprises a stacker board or plate with open window cut outs located above objects to be stacked, lifters located below objects to be stacked and aligned under the open windows of the stacker board or plate, and objects to be stacked that are advanced over the lifters and under the stacker board or plate. The objects to be stacked may be connected to the sheet of material from which they were formed and advanced in a position over the lifters, which lift the objects. If the objects are connected in a sheet prior to lifting, the lifting process may separate the objects from the sheet, onto the stacker board or plate.

The lifted objects engage the bottom of the stacks of previously lifted objects. At least one edge of the lifted object must pass through a “catcher” or stacker hinge. When the lifters are retracted, the objects engage the stacker hinges to separate the lifted objects from the lifters and retain the lifted objects in a stack with those objects previously lifted. Embodiments of the present invention are novel stacker hinges designed to overcome the limitations of the stacker hinges currently known.

The stacker hinge according to an embodiment of the present invention possesses a two-piece construction, a housing and a flipper, for the single stacker hinge and a three-piece construction, a housing and two flippers, for the dual stacker hinge. The flippers for the dual stacker hinge according to at least one embodiment of the present invention are substantially identical and interchangeable, such that only two different components, the housing and the flipper, need to be formed and manufactured for the single or the dual stacker hinge.

The stacker hinge according to an embodiment of the present invention may be injection molded (thermoplastic or resin or any other suitable material). In addition, the flipper components of the stacker hinge according to an embodiment of the present invention may be replaced or exchanged in the stacker hinge housing either with or without removing the stacker hinge housing from the stacker board. One embodiment of the stacker hinge according to an embodiment of the present invention will vertically catch/stack thermoformed blisters or printed card stock or any other suitable object in a stacker magazine. The terms catcher and stacker hinge are used interchangeably in the current application.

### SUMMARY

The stacker hinge according to an embodiment of the present invention comprises a housing and at least one flipper. The at least one flipper attaches to the housing such that the flipper hinges from a first position to a second position. The first position is substantially perpendicular to the vertical axis of the housing and the second position may be substantially parallel to the vertical axis of the housing. The at least one flipper may be releasably attached to the housing. At least one of the: 1) housing and; 2) at least one flipper, may be injection molded. At least one of the: 1) housing and; 2) at least one flipper, may be comprised of a plastic. The at least one flipper may comprise two asymmetrically disposed legs, and at least one may further comprise a boss. The boss may be adapted to communicate with at least one receptacle disposed on the housing. The at least one receptacle may be disposed on an exterior and/or interior wall of the housing.

The stacker hinge according to an embodiment of the present invention comprises a housing, and at least two flippers, wherein the at least two flippers are substantially identical and attach to opposite sides of the housing such that the two flippers independently hinge from a first position to a second position. The stacker hinge may comprise two identically molded flippers that may be used interchangeably with one housing. The at least two substantially identical flippers may be interchangeable. At least one of the at least two substantially identical flippers may be detached from the housing without removing the housing from a stacker board.

### BRIEF DESCRIPTION OF THE DRAWINGS

FIG. 1 A and B is a top view of one embodiment of the single stacker hinge and dual stacker hinge of the present invention, respectively.

FIG. 2 is a top view of one embodiment of a flipper of the present invention.

FIG. 3 is a front view of one embodiment of a flipper of the present invention.

FIG. 4 A and B is a side view of one embodiment of a flipper of the present invention.

FIG. 5 A and B is an end view of one embodiment of the single stacker hinge and dual stacker hinge of the present invention, respectively.

FIG. 6 is a top view of one embodiment of the housing of the present invention.

FIG. 7A and B is a side view of two embodiments of the housing of the present invention.

FIG. 8 is an end view of one embodiment of the housing of the present invention.

### DETAILED DESCRIPTION

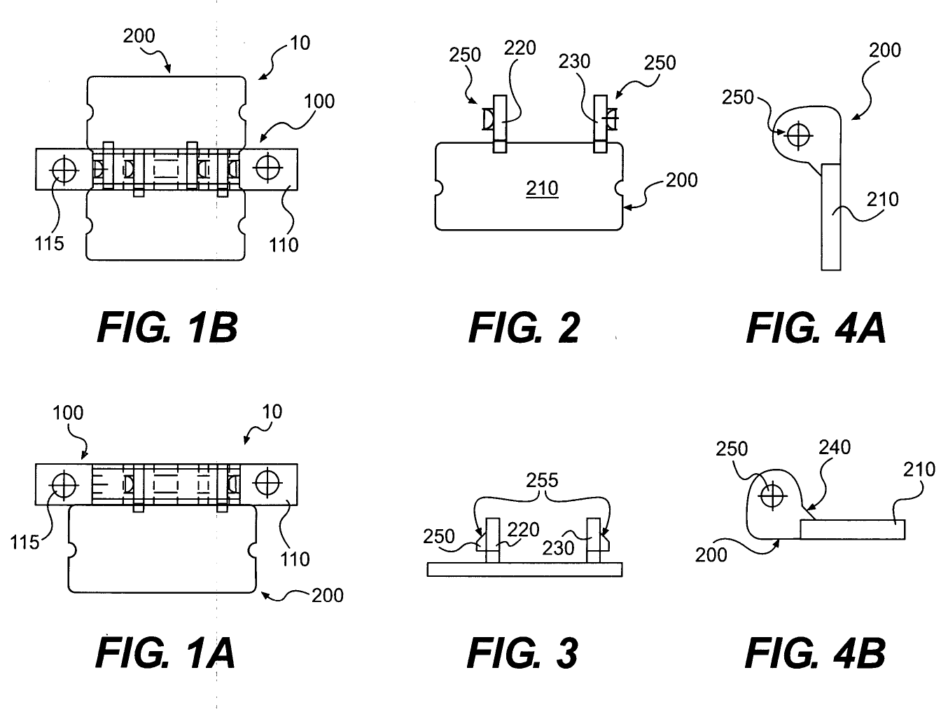

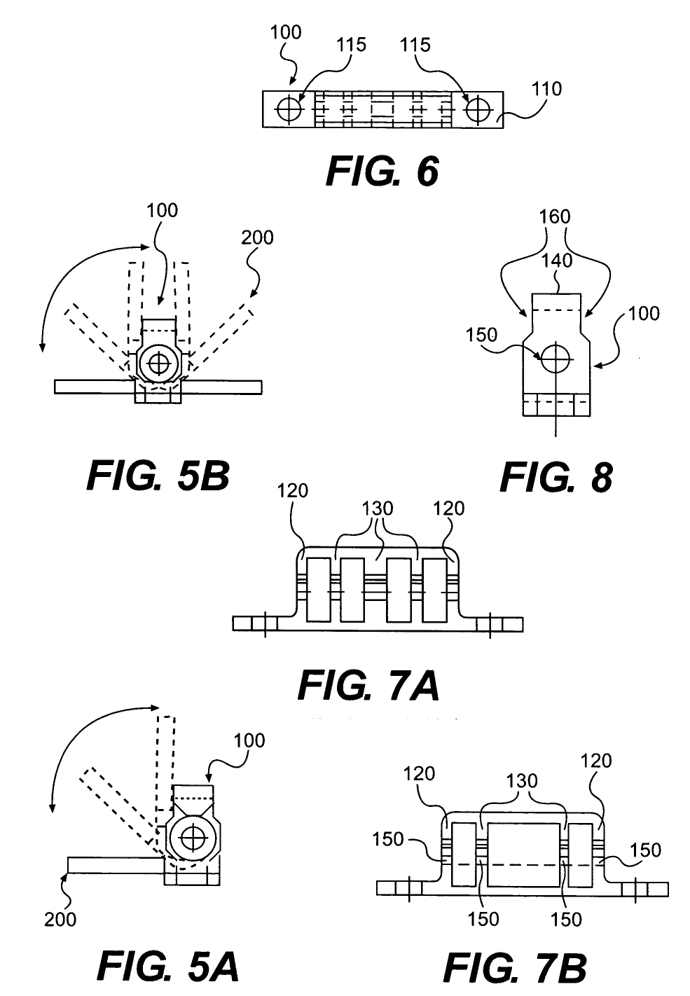

An embodiment of the stacker hinge 10 of the present invention is shown in FIGS. 1A and 1B. The embodiment of stacker hinge 10 comprises housing 100 and at least one flipper 200, wherein at least one flipper 200 attaches to housing 100 such that at least one flipper 200 hinges from a first position substantially perpendicular to the vertical axis of housing 100 to a second position substantially parallel to the vertical axis of housing 100 as shown in FIGS. 5A and B. In normal use at least one flipper 200 may be biased towards the first position by gravity.

One embodiment of stacker hinge 10 of the present invention comprises a housing 100 and at least two flippers 200. As shown in FIG. 1B, stacker hinge 10 of this embodiment comprises housing 100 and two flippers 200, wherein two flippers 200 are substantially identical to each other and attach to housing 100 such that two flippers 200 are on opposite sides of housing 100 and hinge from a first position substantially perpendicular to housing 100 to a second position substantially parallel to housing 100 as shown in FIG. 5B. For purposes of this application, two flippers 200 shall be considered substantially identical when either of two flippers 200, or any other flipper 200, could be interchanged with the other flipper 200 without reasonably affecting the function of stacker hinge 10.

One example of flipper 200 of the present invention is shown in FIGS. 2, 3, and 4. In this embodiment, flipper 200 comprises flipper plate 210 with a first end and a second end, first leg 220, and second leg 230. The location of legs 220 and 230 on plate 210 is not significant other than the fact that flippers 200 are designed to be interchangeable with any other flipper 200. One example of flipper 200 is shown in FIGS. 2 and 3, where first leg 220 is located between the center of plate 210 and the first end of plate 210. Second leg 230 is located between the center of plate 210 and the second end of plate 210. In this embodiment, the distance between first leg 220 and the center of plate 210 and the distance between second leg 230 and the center of plate 210 is different. This asymmetry of the position of legs 220 and 230 with respect to the surface of flipper plate 210 is illustrated in FIG. 2. This is one example of a construction that allows any number of flippers 200 to be interchangeable.

Flippers 200, although substantially identical and interchangeable with each other, each have non-symmetrically placed legs 220 and 230 with respect to the center of flipper plate 210. This non-symmetrical design allows any two of the substantially identical designed and manufactured flipper 200 components to be used for the single flipper 200 or dual flipper 200 stacker hinge 10 according to an embodiment of the present invention. In one embodiment flippers 200 are identical. Flipper 200 can be attached, for example, snapped, into one side of housing 100 to form a single stacker hinge 10 as shown in FIG. 1A, or two flippers 200 may be attached, for example, snapped, into opposite sides of housing 100 to form a dual stacker hinge 10 as shown in FIG. 1B. It is contemplated that any design of flipper 200 that allows flipper 200 to be interchangeable is suitable for this invention. Legs 220 and/or 230 may also comprise gussets or strengthening ribs 240 disposed where legs 220, 230 meet flipper plate 210, as shown in FIG. 4B. The width of ribs 240 may be the same as the width of legs 220, 230 or may increase in width to extend towards the first and/or second ends of flipper plate 210 where rib 240 engages flipper plate 210. The increase in width may provide additional strength in the engagement of legs 220, 230 to flipper 200. The length and angle that rib 240 extends onto flipper plate 210, extending to the opposite edge of flipper plate 210 from where legs 220, 230 engage flipper plate 210, may also vary, as long as the length of rib 240 does not interfere negatively with the objects to be stacked. The increase in length may provide additional strength in the engagement of legs 220, 230 to flipper 200.

Any method of attaching flipper 200 to housing 100 wherein flipper 200 is free to hinge from a first position to a second position can be used. In the embodiment shown in FIGS. 2, 3, and 4, legs 220, 230 have a rounded protrusion or boss 250 extending from a surface of legs 220, 230, for example, in FIGS. 2 and 3, from the outside surface of legs 220, 230. Boss 250 is received by a corresponding receptacle 150 on housing 100, where receptacle 150 may be larger than protrusion or boss 250 on legs 220, 230, allowing flipper 200 to hinge from a first position to a second position.

In this example, boss 250 snap fits into receptacle 150 in housing 100; however, any suitable means of attachment could also be used. In this example, boss 250 has a generally cylindrical shape extending from legs 220, 230 of flipper 200. The top portion, for example, the top half of boss 250 may be chamfered starting from the center of the free end of boss 250 angling upward to the outside of boss 250 where it extends from legs 220, 230, forming a bevel or chamfer 255 in boss 250, as shown in FIG. 3. Chamfer 255 may provide a lead-in angle to facilitate attachment and detachment of flipper 200 from housing 100. However, any shape boss 250 is suitable for the purposes of this invention provided that it allows flipper 200 to hinge from a first position to a second position.

In this example, boss 250 is located on the outside surface of legs 220, 230; however, boss 250 could also be located on the inside surface of legs 220, 230 facing one another or in any combination so long as receptacles 150 on housing 100 are designed to receive boss 250 on legs 220, 230. Boss 250 may also be disposed on the same sides of legs 220, 230, or any combination thereof. Further, other means of attachment that provide hinged movement could also be used, such as but not limited to, any mating arrangement of flipper 200 and housing 100 that allows flipper 200 to move between the first and second positions.

Housing 100 may comprise two exterior walls 120 and any suitable number of interior walls 130. Both exterior walls 120 and interior walls 130, as shown in FIG. 7, may contain receptacles 150, as shown in FIGS. 7 and 8, adapted to receive boss 250 of legs 220, 230 of flipper 200. In one embodiment of housing 100 shown in FIG. 7, housing 100 may comprise either one, two or three interior walls 130. In this embodiment, both interior walls 130 and exterior walls 120 have receptacles 150 for receiving boss 250 on legs 220, 230. However, it is within the scope of this invention that any number of interior walls 130, including none, would be acceptable as long as flipper 200 is attached to housing 100 in a hinged arrangement. Further, it is within the scope of the invention that every interior wall 130 or exterior wall 120 does not have to have receptacles 150 for receiving boss 250. Receptacles 250 are only needed if that is the means in which legs 220, 230 are being attached to the interior walls 130 or exterior walls 120. Further, it is within the scope of this invention to have interior walls 130 or exterior walls 120 that have no receptacles 250 or receptacles 250 on only one side, or receptacles 250 that open to, or pass through, both sides of any particular interior walls 130 or exterior walls 120.

One example of housing 100 of an embodiment of the present invention is shown in FIGS. 6, 7, and 8. Housing 100 may have a rectangular shape with flanges 110 extending from one or more ends of a first or bottom wall. Flanges 110 extend perpendicular to the vertical axis of housing 100 and may be adapted to releasably attach housing 100 to a surface, such as, but not limited to, a stacker board. Housing 100 comprises two outermost exterior walls 120, one each may be in direct communication with flanges 110 used to attach housing 100 with, for example, the stacker board. Housing 100 may also comprise a top wall 140 as shown in FIGS. 7 and 8.

If it is desired to mount housing 100 to a surface, any suitable means of attachment may be used to attach flanges 110 of housing 100 to the surface, including but not limited to screws, nails, nuts, or adhesives. For example, in FIGS. 1, 6, and 7, flanges 110 have mounting holes 115 for receiving screws, nails, bolts, rivets, or any other suitable fastener, that can be used to mount housing 100 to a surface. Holes 115, illustrated in FIG. 6, are located on flanges 110, disposed on opposite ends of housing 100; however, it would be within the scope of the invention to locate holes 115 and flanges 110 anywhere on housing 100 that does not interfere with the stacking of the objects.

In one embodiment of the invention housing 100 may have notch or recess 160, illustrated in FIG. 8, for receiving flipper 200 when flipper 200 is hinged into the second position. As shown in FIG. 5, flipper 200 hinges from a first position where it is substantially perpendicular to the vertical axis of housing 100 to a second position where it is in an upright position against housing 100. Recess 160 in housing 100 allows flipper 200 to hinge further and reduces the distance that flipper 200 protrudes from the body of housing 100 in the second position.

In one embodiment, flippers 200 are designed to hinge from a first position to a second position when they are attached to opposite sides of housing 100. The first position in this embodiment is substantially perpendicular to the vertical axis of housing 100. Housing 100 prevents flippers 200 from hinging past perpendicular. If flipper 200 is desired to hinge past this position, housing 100 could be constructed to allow this movement by removing a portion of housing 100 that prevents flipper 200 from hinging past perpendicular.

In this example, flipper 200 and housing 100 are constructed from an injection molding process. Stacker hinge 10 components may be comprised of thermoplastic, or any other type of suitable resin or other suitable material. Further, any suitable material may be used to construct the components contemplated by the present invention, including but not limited to, plastic, composite, or metal. The components may be formed by any injection molding process, such as, but not limited to, thermoplastic or resin injected molding, co-extrusion, or any other suitable process.

In an example where stacker hinge 10 is used with a stacker machine, the first position can prevent the objects from falling past stacker hinge 10 from a position above stacker hinge 10. The second position of flipper 200 is substantially parallel to the vertical axis of housing 100. This position allows objects to be lifted past flipper 200 from a position below stacker hinge 10. In an embodiment where stacker hinge 10 is used with a stacker machine, flipper 200 will be moved into the second position by an object that passes through stacker hinge 10, for example by passing from underneath through a cut-out window in a stacker board. After the object passes stacker hinge 10, gravity will cause flipper 200 to hinge back or return to the first position. In this embodiment, the second position is substantially parallel to the vertical axis of housing 100 where flipper 200 has hinged approximately 90 degrees from the first position. However, any position at any suitable degree that allows objects to be passed through stacker hinge 10 is suitable for this invention, including positions that are past parallel (hinged more than 90 degrees) or positions that have not reached parallel (hinged less than 90 degrees).

While the present invention has been described with reference to the above described embodiments and alternate embodiments, it should be noted that various other embodiments and modifications may be made without departing from the spirit of the invention. For example, embodiments may posses a single flipper 200 or a dual flipper 200, with housing 100 of from zero to any suitable number of interior walls 130 to support either one or two flippers 200. Housing 100 may or may not comprise a notch or recess 160 to accommodate flipper 200 in the second position. Flipper 200 bosses 250 may be disposed on the outside or inside surface of legs 220, 230, in any combination, to match receptacles 150 on interior walls 130 and/or exterior walls 120 in housing 100. Therefore, the embodiments described herein and the drawings appended hereto are merely illustrative of the features of the invention and should not be construed to be the only variants thereof nor limited thereto.

1. A stacker hinge comprising:
a housing; and
at least one flipper;
wherein the at least one flipper attaches to the housing such that the at least one flipper hinges from a first position to a second position.

2. The stacker hinge of claim 1 wherein the at least one flipper is releasably attached to the housing.

3. The stacker hinge of claim 1 wherein the housing and the at least one flipper are injection molded.

4. The stacker hinge of claim 1 wherein the housing and the at least one flipper are comprised of a plastic.

5. The stacker hinge of claim 1 wherein the at least one flipper comprises two asymmetrically disposed legs.

6. The stacker hinge of claim 5 wherein at least one of the asymmetrically disposed legs further comprises a boss.

7. The stacker hinge of claim 1 wherein the at least one flipper comprises at least one leg having a boss, wherein the boss is adapted to communicate with at least one receptacle disposed on the housing.

8. The stacker hinge of claim 7 wherein the at least one receptacle is disposed on an exterior wall of the housing.

9. The stacker hinge of claim 7 wherein the at least one receptacle is disposed on an interior wall of the housing.

10. A stacker hinge comprising:
a housing; and
at least two flippers;
wherein the at least two flippers are substantially identical and attach to opposite sides of the housing such that the two flippers independently hinge from a first position to a second position.

11. The stacker hinge of claim 10 wherein the at least two substantially identical flippers are used simultaneously with one housing.

12. The stacker hinge of claim 10 wherein the at least two substantially identical flippers are interchangeable.

13. The stacker hinge of claim 10 wherein at least one of the at least two substantially identical flippers may be detached from the housing without removing the housing from a stacker board.

14. A stacker hinge comprising:
a housing comprising at least two walls;
at least one flipper comprising at least two asymmetrically disposed legs;
wherein the at least two asymmetrically disposed legs further comprises a boss; and
wherein at least two of the at least two walls further comprises a receptacle adapted to receive the boss.

15. The stacker hinge of claim 14 wherein the housing comprises two exterior walls and at least one interior wall.

16. The stacker hinge of claim 14 wherein at least one of the least two asymmetrically disposed legs further comprises a rib.

17. The stacker hinge of claim 14 wherein at least one boss is chamfered.

18. A stacker hinge comprising:
a housing; and
at least one flipper having at least one leg;
wherein the at least one leg further comprises a boss; and
wherein the at least one flipper attaches to the housing such that the at least one flipper hinges from a first position to a second position.

19. The stacker hinge of claim 18 wherein the boss communicates with a receptacle disposed on the housing.

20. The stacker hinge of claim 18 wherein the housing comprises two exterior walls and a top wall.

21. A stacker hinge comprising:
a housing; and
at least one flipper having two legs;
wherein at least one of the two legs further comprises a boss; and
wherein at least one of the two legs attaches to the housing such that the at least one flipper hinges from a first position to a second position.
